(19) United States
(12) Patent Application Publication
(10) Pub. No.: US 2016/0062336 A1
(43) Pub. Date: Mar. 3, 2016

(54) NUMERICAL CONTROLLER FOR FACILITATING ADJUSTMENT OF MACHINING MOTION

(71) Applicant: FANUC Corporation, Yamanashi (JP)

(72) Inventors: Ryuta HITOMI, Minamitsuru-gun (JP); Hideaki MAEDA, Minamitsuru-gun (JP); Shinya NAKAMURA, Minamitsuru-gun (JP)

(21) Appl. No.: 14/825,449

(22) Filed: Aug. 13, 2015

(30) Foreign Application Priority Data
Aug. 28, 2014 (JP) 2014-174180

(51) Int. Cl. G05B 19/18

(52) U.S. Cl. CPC G05B 19/182; G05B 2219/49108

(57) ABSTRACT

A numerical controller generates machining change information on the basis of information on a currently executed block and a machining change signal input by an operator, converts the machining change information into a machining change program, merges the machining change program obtained through the conversion with the machining program, and generates a command for controlling a plurality of motors and a plurality of peripheral devices on the basis of the machining program after the merging.

### BACKGROUND OF THE INVENTION

1. Field of the Invention

The present invention relates to a numerical controller for facilitating adjustment of spindle speed or a feed rate.

2. Description of the Related Art

In order to optimize spindle rotational frequency or a feed rate of a machining program, an operator has repeatedly performed trial machining while overriding the spindle rotational frequency or the feed rate and revised the spindle rotational frequency or the feed rate of the machining program according to each result of the trial machining.

Providing a numerical controller with a function of reflecting actual spindle rotational frequency or actual feed rate during trial machining in a machining program used for the trial machining to aid in the above-described trial machining and machining program revision is a known technique.

As a technique related to such a known technique, a technique for sequentially storing each override value set in machining during execution of a unique interactive program and changing the machining program on the basis of information on override values stored so far after completion of the machining is disclosed in Japanese Application Patent Laid-Open No. 07-227739. A technique for writing, when an override value is changed during execution of a machining program, an override value after the block concerned is also disclosed in Japanese Application Patent Laid-Open No. 63-047805. A technique for immediately rewriting a machining program by pressing a program revision command switch when an override value is changed during execution of the machining program is further disclosed in Japanese Application Patent Laid-Open No. 58-132439.

Since trial machining or machining for optimizing an already used program is repeatedly performed through trial and error, spindle rotational frequency or a feed rate at the time of machining performed last is not always an optimum value. For this reason, an operator makes copies of an original machining program, keeps a revision history of the machining program through performing trial machining with each copy of the machining program, and selects an optimum copy of the machining program from the revision history.

As described above, at the time of repetition of trial machining and machining program revision according to prior art technique, an effort of making a copy of an original machining program is required, and s whole of the machining program needs to be copied despite the fact that a location to be revised in the machining program is only a part thereof, such as spindle rotational frequency or a feed rate. If machining program saving is performed each time trial machining is performed, memory is consumed by an amount corresponding to the product of the size of the original machining program and the number of history records.

At the time of comparison of a version before revision of a machining program with a version after the revision of the machining program, since only a part associated with spindle rotational frequency or feed rate of the machining program has been changed, a part where change was made is difficult to identified.

### SUMMARY OF THE INVENTION

Under the circumstances, it is an object of the present invention to provide a numerical controller capable of easily reflecting, in a machining program, a plurality of adjusted values for spindle rotational frequency and a feed rate which are obtained through repetition of trial machining and change in a plurality of states, such as coolant on/off, of a peripheral device.

A numerical controller according to the present invention includes an operation execution section which generates a command for controlling a plurality of motors and a plurality of peripheral devices on a basis of a machining program and a machining change signal input by an operator, a machining change signal reception section which receives the machining change signal, a machining change information recording section which generates machining change information on a basis of the machining change signal acquired from the machining change signal reception section and information on a currently executed block acquired from the operation execution section and records the machining change information, a machining change information program conversion section which converts the machining change information recorded in the machining change information recording section into a machining change program, a machining change program storage section which stores the machining change program, and a machining program merging processing section which merges the machining program with the machining change program stored in the machining change program storage section. The machining change program storage section stores a plurality of the machining change programs, the machining program merging processing section merges the machining program with a machining change programs which is selected from the machining change program storage section by the operator, and the operation execution section generates the command for controlling the plurality of motors and the plurality of peripheral devices on a basis of the machining program merged by the machining program merging processing section.

The machining change information can include any one of actual spindle rotational frequency, an actual feed rate, a product of an override value and modal spindle rotational frequency, a product of an override value and a feed rate, an override value, a code indicating a miscellaneous function, a tool section code, and a second miscellaneous function code.

The numerical controller proposed by the present invention need not make a copy of an original machining program at the time of repetition of trial machining and can record revised values for spindle rotational frequency and a feed rate and statuses of peripheral devices, using a machining change program. For this reason, the working efficiency of trial machining and machining program revision by an operator can be improved. Additionally, since the machining change program to be recorded is mainly composed of data, such as spindle rotational frequency or a feed rate, less memory is consumed than in a case where the original machining program is copied, and consumption of memory resources used to repeatedly perform trial machining is reduced. Moreover, comparison between programs before and after revision is easier.

### BRIEF DESCRIPTION OF THE DRAWINGS

The above and other objects and features of the present invention will be apparent from the following description of an embodiment with reference to the appended drawings, in which:

FIG. 1 is a functional block diagram of a numerical controller according to one embodiment of the present invention;

FIG. 2 is a view showing an example in which machining change information recorded in the numerical controller in FIG. 1 is converted into a machining change program during execution of a machining program by the numerical controller;

FIG. 3 is a flowchart showing the overall flow of processing to be executed on the numerical controller in FIG. 1;

FIG. 4 is a flowchart showing the flow of a machining program optimization process to be executed by the numerical controller in FIG. 1;

FIG. 5 is a flowchart showing the flow of processing which records machining change information to be executed by the numerical controller in FIG. 1;

FIG. 6 is a flowchart showing the flow of machining change information program conversion processing to be executed by the numerical controller in FIG. 1;

FIG. 7 is a flowchart showing the flow of processing to be executed by the numerical controller in FIG. 1, which merges a machining program with a machining change program and carries out operation; and

FIG. 8 is a flowchart showing the flow of processing to be executed by the numerical controller in FIG. 1, which carries out operation while merging a machining program with a machining change program.

### DETAILED DESCRIPTION OF THE PREFERRED EMBODIMENTS

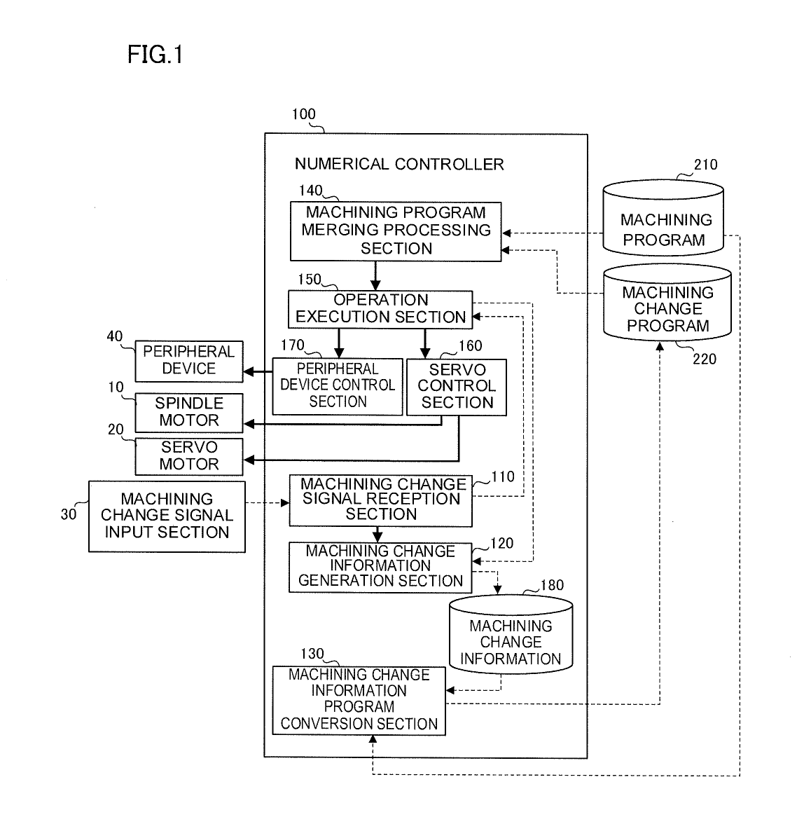

A numerical controller 100 according to one embodiment of the present invention will be described with reference to FIG. 1.

The numerical controller 100 includes a machining change signal reception section 110, a machining change information generation section 120, a machining change information program conversion section 130, a machining program merging processing section 140, an operation execution section 150, a servo control section 160, and a peripheral device control section 170.

The machining change signal reception section 110 receives a machining change signal input by an operator or the like via a machining change signal input section 30 which is composed of an override switch or the like and passes the received machining change signal to the machining change information generation section 120 and the operation execution section 150.

The machining change information generation section 120 generates a piece of machining change information on the basis of a machining change signal received from the machining change signal reception section 110 and information on a block currently being executed received from the operation execution section 150 and passes the generated piece of machining change information to a recording section 180. The machining change information generation section 120 generates a piece of machining change information each time a current machining change signal is replaced with another and passes the generated piece of machining change information to the recording section 180 for recording.

A piece of machining change information is information in which a block number is associated with actual spindle rotational frequency or actual feed rate. The actual spindle rotational frequency or actual feed rate is a value obtained by overriding spindle rotational frequency or a feed rate specified in a machining program (i.e., actual spindle speed or an actual control axis feed rate). Note that information to be recorded as a piece of machining change information is not limited to actual spindle rotational frequency or actual feed rate and may be any one of the following pieces of information:

(1) a value obtained by multiplying an override value (%) by modal spindle rotational frequency (S) or a feed rate (F);
(2) an override value (%);
(3) a miscellaneous function (M-code) (e.g., coolant on/off, hard clamping on/off, soft clamping on/off, rigid tap mode on/off, custom macro interrupt on/off, mirror image on/off, spindle normal/reverse rotation, air blow on/off, or automatic door open/close);
(4) tool selection information (T-, D-, or H-code); and
(5) a second miscellaneous function (B-code).

The machining change information program conversion section 130 converts a piece of machining change information recorded in the recording section 180 into a program format (a machining change program) corresponding to a block number and stores the machining change information in a machining change program storage section 220. A machining change program to be stored in the machining change program storage section 220 is a program with a word defining a value of actual spindle rotational frequency, an actual feed rate, or the like in a block, which has been overridden at the time of execution of a machining program.

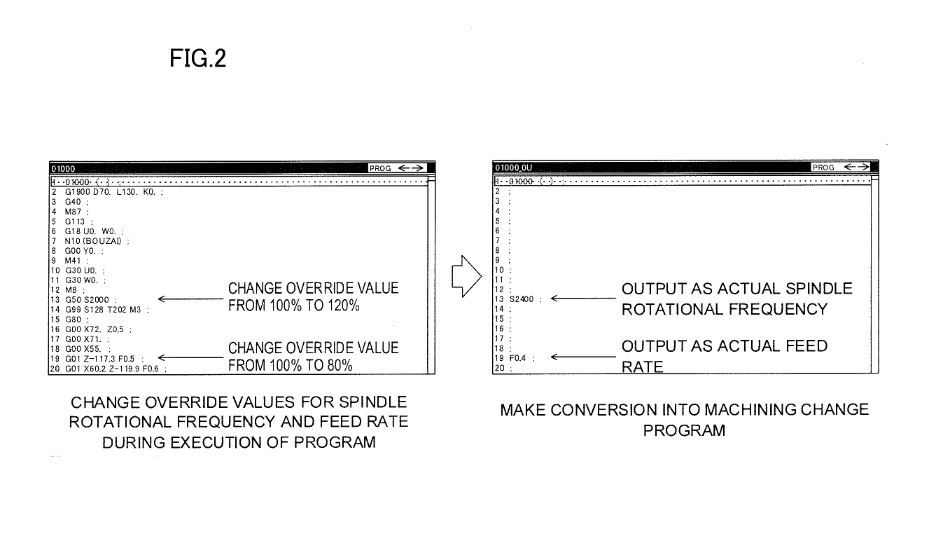

FIG. 2 is a view showing an example in which a piece of machining change information, which is recorded in the recording section 180 when block 13 is overridden to change spindle rotational frequency to 120% (from 100%) and block 19 is overridden to change a feed rate to 80% (from 100%) during execution of a machining program O1000, is converted into “a machining change program”.

As indicated in a screen on the right side of FIG. 2, block 13 of a machining change program O1000_OVR01 describes S2400, serving as a word available to the code G50 described in corresponding block 13 of the machining program O1000, which defines actual spindle rotational frequency. Corresponding block 19 of the machining change program O1000_VR01 describes F0.4, serving as a word available to the code G01 described in block 19 of the corresponding machining program O1000, which defines an actual feed rate.

Referring back to FIG. 1, the machining program merging processing section 140 merges a machining program read out from a machining program storage section 210 with a machining change program read out from the machining change program storage section 220. A machining program, with which a machining change program is merged as described above, is temporarily recorded in a work area provided in a RAM or the like. The recorded machining program, with which the machining change program is merged, is read out and executed by the operation execution section 150. Note that the present invention is not limited to this. A machining program read out from the machining program storage section 210 may be merged with a machining change program block by block, and each machining block, with which a corresponding block of the machining change program is merged, may be successively executed by the operation execution section 150.

A machining program and a machining change program displays, on a display screen of a display (not shown) of the numerical controller 100, a list of machining programs and machining change programs corresponding to each machining program, and a machining program and its corresponding machining change program may be selected on the screen and loaded in accordance with an instruction by an operator.

Merging processing of a machining program with a machining change program is executed by, for example, overwriting or adding a word for specifying a spindle speed or feed rate, which is described in a corresponding block of the machining program. In the case of the machining change program shown in FIG. 2, for example, with words (“S2400” and “F0.4”) described in blocks 13 and 19 of the machining change program O1000_OVR01 (on the right side of FIG. 2), words with the same addresses described in corresponding blocks of the machining program (on the left side of FIG. 2) may be overwritten. Note that merging processing is not limited to simple overwriting or addition of a word. Merging of a machining program with a machining change program may be performed by any other method as long as actual spindle rotational frequency and an actual feed rate when a machining change signal is input during trial machining operation can be reproduced in the machining program after the merging.

Referring again back to FIG. 1, the operation execution section 150 generates a command for controlling a spindle motor 10, a servomotor 20, and a peripheral device 40 from a merged machining program created by the machining program merging processing section 140 and an override value acquired from the machining change signal reception section 110 and outputs the generated command to the servo control section 160 and the peripheral device control section 170. The servo control section 160 controls the spindle motor 10 and the servomotor 20 in accordance with a command acquired from the operation execution section 150. The peripheral device control section 170 controls the peripheral device 40 in accordance with a command acquired from the operation execution section 150.

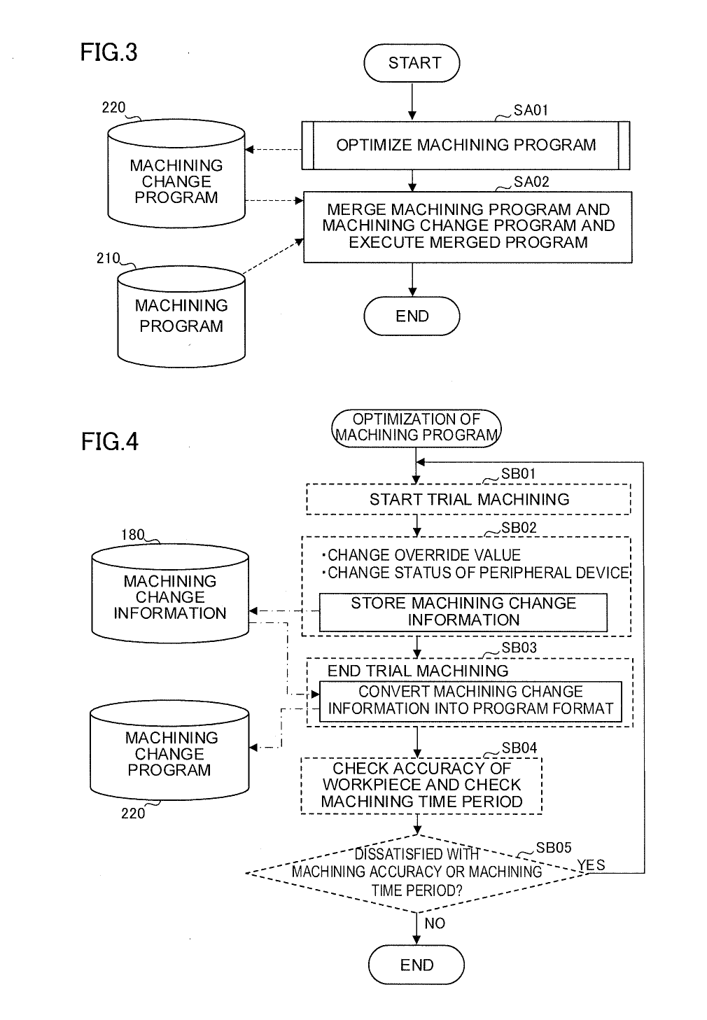

The processes to be executed on the numerical controller 100 described thus far will be described below with reference to flowcharts in FIGS. 3 to 7.

FIG. 3 is a flowchart showing the overall flow of processing to be executed on the numerical controller 100.
[Step SA01] In a machining program optimization process involving repetition of trial machining, a signal from the machining change signal input section 30 is recorded, a machining change program is generated, and the generated machining change program is stored in the machining change program storage section 220.
[Step SA02] The machining change program generated in step SA01 is merged with a machining program read out from the machining program storage section 210, and machining motion based on the optimized machining program is performed.

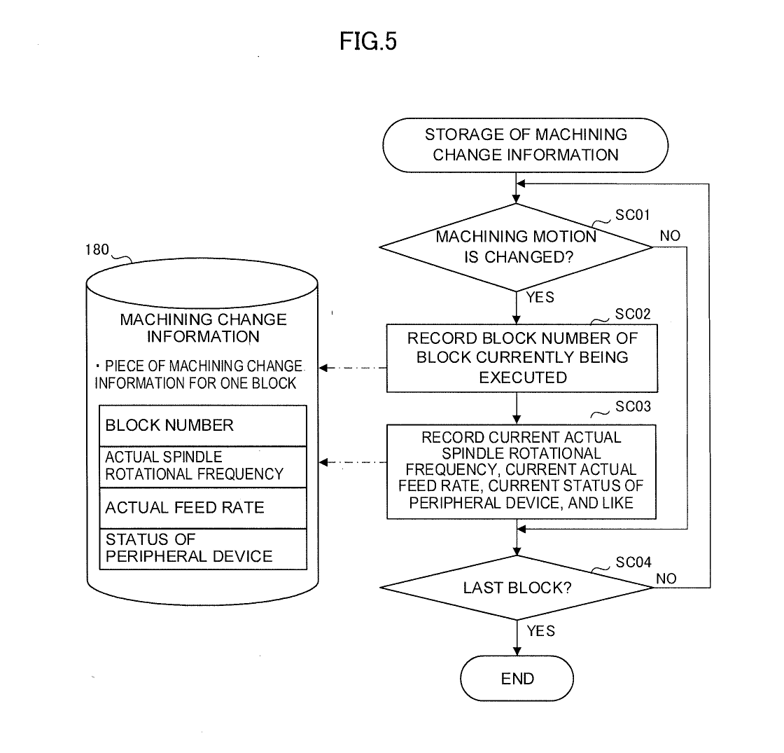

FIG. 4 is a flowchart showing the flow of the machining program optimization process. Note that a dotted frame in the flowchart indicates a working process by a worker and that a solid frame indicates processing to be executed on the numerical controller 100.
[Step SB01] Trial machining by an operator is started. The trial machining is started when a machining program stored in the machining program storage section 210 is read out, and the read-out machining program is processed in the operation execution section 150 without being merged with a machining change program.
[Step SB02] When the machining change signal input section 30 is manipulated by the operator to change an override value for spindle rotational frequency or a feed rate during the trial machining, the machining change signal reception section 110 receives a machining change signal which is output on the basis of the change manipulation. The machining change information generation section 120 generates a piece of machining change information on the basis of the received machining change signal and passes the generated piece of machining change information to the recording section 180 for recording.
[Step SB03] When operation based on the machining program is ended, the trial machining is ended through a manipulation by the operator. After the end of the trial machining, the machining change information program conversion section 130 converts pieces of machining change information recorded in the recording section 180 into a machining change program, for example, in response to a manipulation by the operator and passes the machining change program obtained through the conversion to the machining change program storage section 220 for storage.
[Step SB04] The operator checks the accuracy of a workpiece machined through the trial machining and a machining time period spent on the machining.
[Step SB05] If the operator is satisfied with the machining accuracy and the machining time period in the trial machining this time and determines that the machining program is optimized, after the checking in step SB04, the optimization working process ends. On the other hand, if the operator determines that the machining program is not yet optimized, the flow returns to step SB01 to resume the trial machining.

FIG. 5 is a flowchart showing the flow of processing which records a piece of machining change information in the machining program optimization process.
[Step SC01] The machining change information generation section 120 determines whether a machining change signal is replaced with another through a manipulation of the machining change signal input section 30 by an operator during trial machining motion by the operation execution section 150. If it is determined that the machining change signal is replaced with another, the flow proceeds to step SC02. On the other hand, if it is not determined that the machining change signal is replaced with another (input of another machining change signal is not detected), the flow proceeds to step SC04.
[Step SC02] The machining change information generation section 120 passes the block number of a block, currently being executed in the trial machining, of a machining program is passed to the recording section 180.
[Step SC03] The machining change information generation section 120 associates actual spindle rotational frequency and an actual feed rate in currently executed machining during the trial machining with the block number recorded in step SC02 and passes the pieces of data to the recording section 180.
[Step SC04] It is checked whether execution of machining processing is ended to the last block of the machining program being executed by the operation execution section 150. If the execution is ended to the last block, the trial machining operation using the machining program this time ends. On the other hand, if the execution is not yet ended to the last block, the flow returns to step SC01 to continue the trial machining operation.

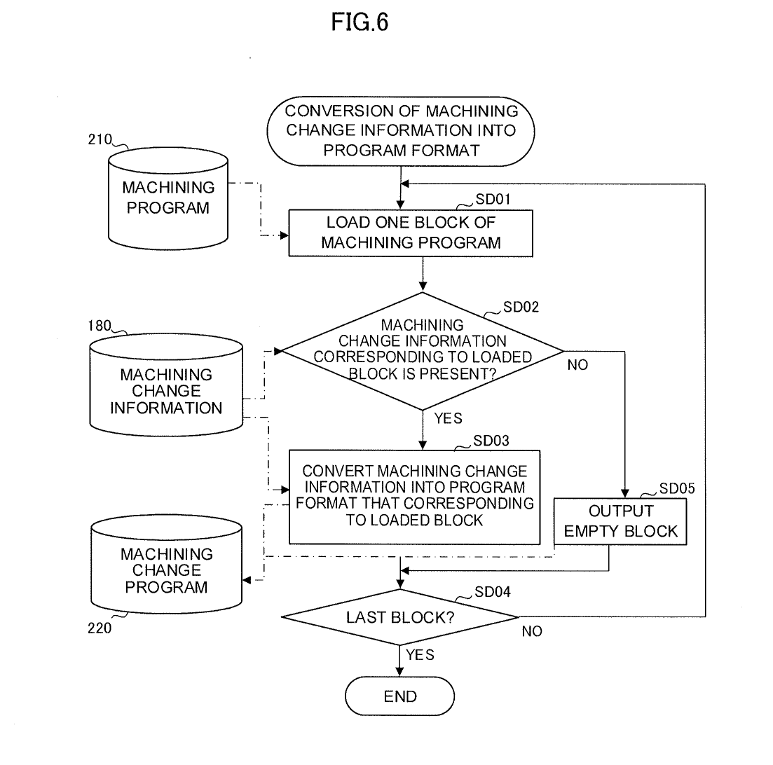

FIG. 6 is a flowchart showing the flow of processing, which converts a piece of machining change information into a machining change program, to be executed by the machining change information program conversion section 130.
[Step SD01] A machining program used for trial machining is loaded block by block.
[Step SD02] It is checked whether a piece of machining change information corresponding to a loaded block is recorded in the recording section 180. If a corresponding piece of machining change information is recorded, the flow proceeds to step SD03; otherwise, the flow proceeds to step SD05.
[Step SD03] The piece of machining change information corresponding to the block loaded from the machining program in step SD01 is converted into program format so as to have a form commensurate with the block.
[Step SD04] It is checked whether the machining program is loaded to a last block. If the machining program is loaded to the last block, the conversion processing ends. On the other hand, if the machining program is not loaded to the last block, the flow returns to step SD01.
[Step SD05] Since there is no corresponding piece of machining change information, an empty block is output.

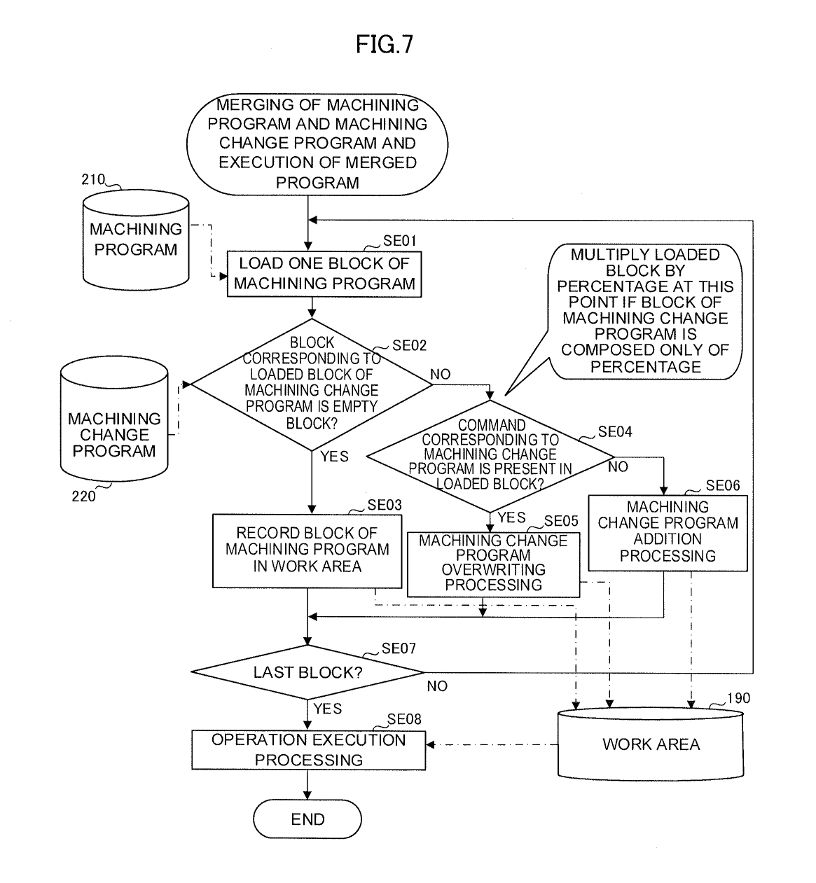

FIG. 7 is a flow chart showing the flow of processing which separately reads out a machining program stored in the machining program storage section 210 and a machining change program stored in the machining change program storage section 220, merges the programs, and executes machining operation.
[Step SE01] A machining program serving as an object of machining operation is sequentially read out from the machining program storage section 210 block by block.
[Step SE02] A block of a machining change program, which corresponds to a block of the machining program, read out in step SE01, is read out from the machining change program storage section 220, and it is determined whether the read-out block of the machining change program is an empty block or not. If the read-out block is an empty block, the flow proceeds to step SE03; otherwise, the flow proceeds to step SE04.
[Step SE03] Blocks of the machining program, read out in step SE01, are sequentially recorded in a work area 190 without change.
[Step SE04] It is determined whether there is a command corresponding to the block of the machining change program, read out in step SE02, in a block of the machining program, read out in step SE01. If there is a corresponding command, the flow proceeds to step SE05. On the other hand, if there is no corresponding command, the flow proceeds to step SE06.
[Step SE05] A word specifying actual spindle rotational frequency or actual feed rate in each block of the machining program, read out in step SE01, is overwritten with a word described in the block of the machining change program, read out in step SE02, and each block is sequentially recorded in the work area 190.
[Step SE06] The word in the block of the machining change program, read out in step SE02, is added to a command described in each block of the machining program, read out in step SE01, and each block is sequentially recorded in the work area 190.
[Step SE07] It is checked whether the machining program is loaded to a last block. If the machining program is loaded to the last block, the merging processing ends, and the flow proceeds to step SE08. On the other hand, if the machining program is not loaded to the last block, the flow returns to step SE01.
[Step SE08] The operation execution section 150 reads out the merged machining program recorded in the work area 190 in steps SE01 to SE06 and executes machining operation.

Note that if a piece of information described in the machining change program is composed only of an override value (%), the merging processing is performed by replacing a value of a corresponding block of the machining program with a value obtained by multiplying the value by the override value (%).

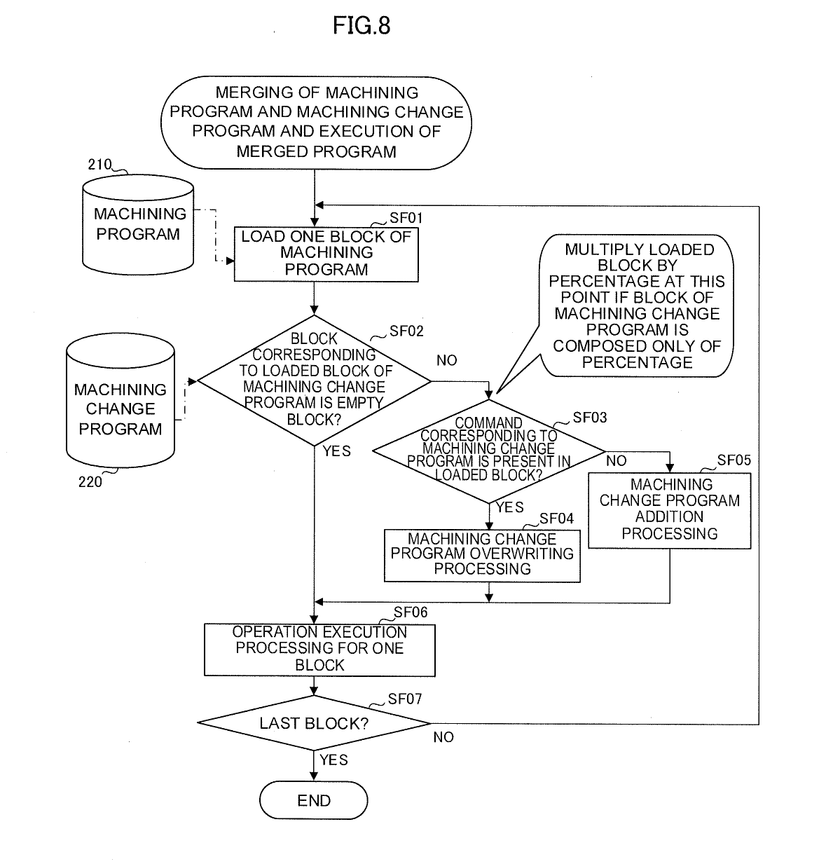

FIG. 8 is a flowchart showing the flow of processing which successively executes machining operation while separately reading out a machining program stored in the machining program storage section 210 and a machining change program stored in the machining change program storage section 220 and merging the programs.
[Step SF01] A machining program serving as an object of machining operation is sequentially read out from the machining program storage section 210 block by block.
[Step SF02] A block of a machining change program which corresponds to a block of the machining program, read out in step SF01, is read out from the machining change program storage section 220, and it is determined whether the read-out block of the machining change program is an empty block or not. If the read-out block is an empty block, the flow proceeds to step SF06; otherwise, the flow proceeds to step SF03.
[Step SF03] It is determined whether there is a command corresponding to the block of the machining change program, read out in step SF02, in a block of the machining program, read out in step SF01. If there is a corresponding command, the flow proceeds to step SF04. On the other hand, if there is no corresponding command, the flow proceeds to step SF05.
[Step SF04] A word specifying actual spindle rotational frequency or actual feed rate in each block of the machining program, read out in step SF01, is overwritten with a word described in the block of the machining change program, read out in step SF02.
[Step SF05] The word in the block of the machining change program, read out in step SF02, is added to a command described in each block of the machining program, read out in step SF01.
[Step SF06] The operation execution section 150 executes machining operation for one block.
[Step SF07] It is checked whether the machining program is loaded to a last block. If the machining program is loaded to the last block, the machining operation ends. On the other hand, if the machining program is not loaded to the last block, the flow returns to step SF01.

What is claimed is:

1. A numerical controller comprising:
an operation execution section which generates a command for controlling a plurality of motors and a plurality of peripheral devices on a basis of a machining program and a machining change signal input by an operator;
a machining change signal reception section which receives the machining change signal;
a machining change information recording section which generates machining change information on a basis of the machining change signal acquired from the machining change signal reception section and information on a currently executed block acquired from the operation execution section and records the machining change information;
a machining change information program conversion section which converts the machining change information recorded in the machining change information recording section into a machining change program;
a machining change program storage section which stores the machining change program; and
a machining program merging processing section which merges the machining program with the machining change program stored in the machining change program storage section,
wherein the machining change program storage section stores a plurality of the machining change programs,
the machining program merging processing section merges the machining program with a machining change programs which is selected from the machining change program storage section by the operator, and
the operation execution section generates the command for controlling the plurality of motors and the plurality of peripheral devices on a basis of the machining program merged by the machining program merging processing section.

2. The numeral control according to claim 1, wherein the machining change information includes any one of actual spindle rotational frequency, an actual feed rate, a product of an override value and modal spindle rotational frequency, a product of an override value and a feed rate, an override value, a code indicating a miscellaneous function, a tool section code, and a second miscellaneous function code.
